(19) United States
(12) Patent Application Publication
(10) Pub. No.: US 2014/0223977 A1
(43) Pub. Date: Aug. 14, 2014

(54) BURGLARPROOF LOCK CORE ASSEMBLY

(71) Applicants: Hsiu-Chuan Wu, Kaohsiung (TW); Chien-Feng Hung, Pingtung County (TW)

(72) Inventors: Hsiu-Chuan Wu, Kaohsiung (TW); Chien-Feng Hung, Pingtung County (TW)

(21) Appl. No.: 13/762,709

(22) Filed: Feb. 8, 2013

(51) Int. Cl. E05B 27/00

(52) U.S. Cl. CPC E05B 27/0057
USPC 70/493

(57) ABSTRACT

A burglarproof lock core assembly has a lock shell, a lock core and a pin device. The lock shell has a mounting recess, multiple upper pin chambers and an engaging slot. The lock core is mounted in the mounting recess and has a keyhole, multiple lower pin chambers, multiple sliding channels, multiple sliding rods, a tab recess and an engaging tab. The sliding channels are formed through the lock core near the lower pin chambers. The sliding rods are mounted in the sliding channels, and each has a releasing recess, a burglar-misleading recess and at least one guiding post. The tab recess communicates with the sliding channels and selectively faces the engaging slot. The engaging tab is mounted between the engaging slot and the tab recess. The pin device is mounted between the lock shell and the lock core and has multiple pin sets mounted in the pin chambers.

### BACKGROUND OF THE INVENTION

1. Field of the Invention

The present invention relates to a burglarproof lock core assembly, and more particularly to a burglarproof lock core assembly that can provide an enhanced burglarproof effect.

2. Description of Related Art

A conventional lock core assembly is mounted in a door to provide a burglarproof effect and usually has a lock shell, a lock core and multiple pin assemblies. The lock core is mounted rotatably in the lock shell and has a keyhole and an interface. The interface is defined between the lock core and the lock shell. The pin assemblies are respectively mounted through the lock shell and in the lock core, and each pin assembly has a lower pin, an upper pin and a spring. The lower pins are mounted slidably in the lock core and have various lengths. The upper pins have a bottom, are mounted slidably in the lock shell, and the bottoms of the upper pins abut the tops of the lower pins. The springs are mounted between the upper pins and the lock shell to press the upper pins against the lower pins.

Therefore, the upper pin of each pin assembly is disposed at the interface between the lock core and lock shell. To open the lock, a key having multiple corresponding ridges of various lengths is inserted into the keyhole. The multiple ridges correspond in length to the lower pins and push the lower pins against the springs, causing the bottoms of the upper pins and tops of the lower pins to align with the interface between the lock shell and lock core and allow the lock core to rotate relative to the lock shell.

However, a burglar may use a lock pick to vibrate or knock the burglarproof lock core assembly, thereby forming a gap between the upper and lower pins of the pin assemblies. When the gap between the upper and lower pins of the pin assemblies are aligned with the interface between the lock shell and the lock core, the burglar can turn the lock core relative to the lock shell to unlock the burglarproof lock core assembly. Therefore, the conventional burglarproof lock core assembly requires improvement for burglarproofing.

To overcome the shortcomings, the present invention provides a burglarproof lock core assembly to mitigate or obviate the aforementioned problems.

### SUMMARY OF THE INVENTION

The primary objective of the present invention is to provide a burglarproof lock core assembly that can provide an enhanced burglarproof effect.

The burglarproof lock core assembly in accordance with the present invention has a lock shell, a lock core and a pin device. The lock shell has a mounting recess, multiple upper pin chambers and an engaging slot. The lock core is mounted in the mounting recess and has a keyhole, multiple lower pin chambers, multiple sliding channels, multiple sliding rods, a tab recess and an engaging tab. The sliding channels are formed through the lock core near the lower pin chambers. The sliding rods are mounted in the sliding channels, and each has a releasing recess, a burglar-misleading recess and at least one guiding post. The tab recess communicates with the sliding channels and selectively faces the engaging slot. The engaging tab is mounted between the engaging slot and the tab recess. The pin device is mounted between the lock shell and the lock core and has multiple pin sets mounted in the pin chambers.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a burglarproof lock core assembly in accordance with the present invention, shown with a corresponding key inserted into the burglarproof lock core assembly;

FIG. 2 is a perspective view in partial section of the burglarproof lock core assembly in FIG. 1;

FIG. 3 is an exploded perspective view of the burglarproof lock core assembly in FIG. 1;

FIG. 4 is an enlarged exploded perspective view in partial section of a lock core of the burglarproof lock core assembly in FIG. 3;

FIG. 5 is an enlarged top view of a sliding pin of the lock core of the burglarproof lock core assembly in FIG. 4;

FIG. 6 is a side view in partial section of the burglarproof lock core assembly in FIG. 1, shown without the corresponding key;

FIG. 7 is an enlarged rear view in partial section of the burglarproof lock core assembly along line 7-7 in FIG. 6;

FIG. 8 is an operational side view in partial section of the burglarproof lock core assembly in FIG. 1, shown with the corresponding key;

FIG. 9 is an enlarged operational rear view in partial section of the burglarproof lock core assembly along line 9-9 in FIG. 8; and

FIG. 10 is another operational rear view in partial section of the burglarproof lock core assembly along line 9-9 in FIG. 8 to rotate the lock core relative to a lock shell of the burglarproof lock core assembly.

### DETAILED DESCRIPTION OF THE PREFERRED EMBODIMENT

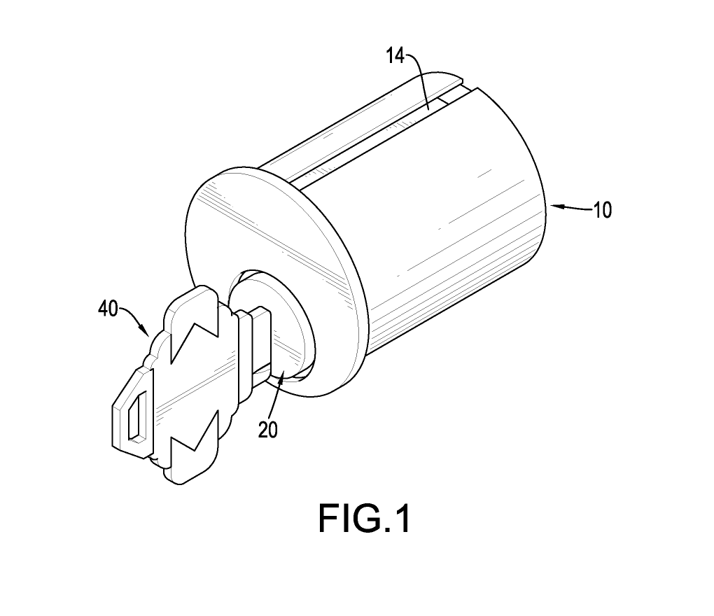

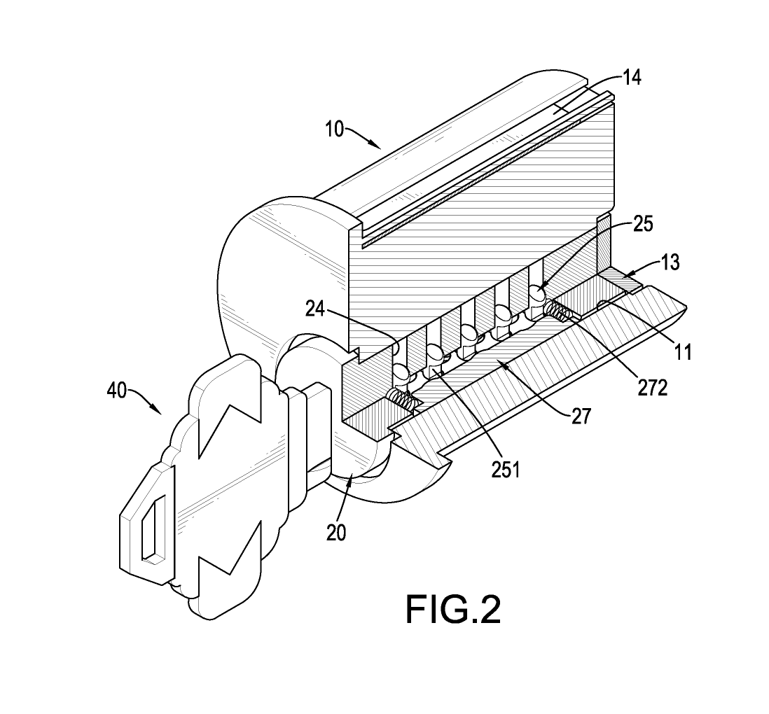

With reference to FIGS. 1 to 3, a burglarproof lock core assembly in accordance with the present invention has a lock shell 10, a lock core 20, a pin device 30 and a key 40.

The lock shell 10 has an outer surface, a front side, a rear side, a mounting recess 11, multiple upper pin chambers 12, an engaging slot 13 and a lid 14. The mounting recess 11 is formed through the front side and the rear side of the lock shell 10 and has an inner surface. The upper pin chambers 12 are formed radially in the outer surface of the lock shell 10 at intervals, align longitudinally with each other, and communicate with the mounting recess 11. The engaging slot 13 is formed through the front side of the lock shell 10 and is formed in the inner surface of the mounting recess 11. The lid 14 is mounted detachably on the outer surface of the lock shell 10 and covers the upper pin chambers 12.

The lock core 20 is mounted rotatably in the mounting recess 11 of the lock shell 10 and has an outer surface, an interface, an outer end, an inner end, a keyhole 21, multiple lower pin chambers 22, a cap 23, multiple sliding channels 24, multiple sliding rods 25, a tab recess 26 and an engaging tab 27.

The interface is defined between the outer surface of the lock core 20 and the inner surface of mounting recess 11 of the lock shell 10. The keyhole 21 is formed through the ends and a part of the outer surface of the lock core 20. The lower pin chambers 22 are formed radially in the outer surface of the lock core 20 at intervals, communicate with the keyhole 21, align with, correspond to and communicate with the upper pin chambers 12 of the lock shell 10. Preferably, the lock core 20 has six lower pin chambers 22.

The cap 23 is mounted in the mounting recess 11 of the lock shell 10 and is connected to the inner end of the lock core 20 by a fastener 231 to close the key hole 21. The sliding channels 24 are radially formed through the outer surface of the lock core 20 at intervals and communicate with the keyhole 21. Each one of the sliding channels 24 is formed through the lock core 20 near two adjacent lower pin chambers 22. Preferably, the lock core 20 has five sliding channels 24.

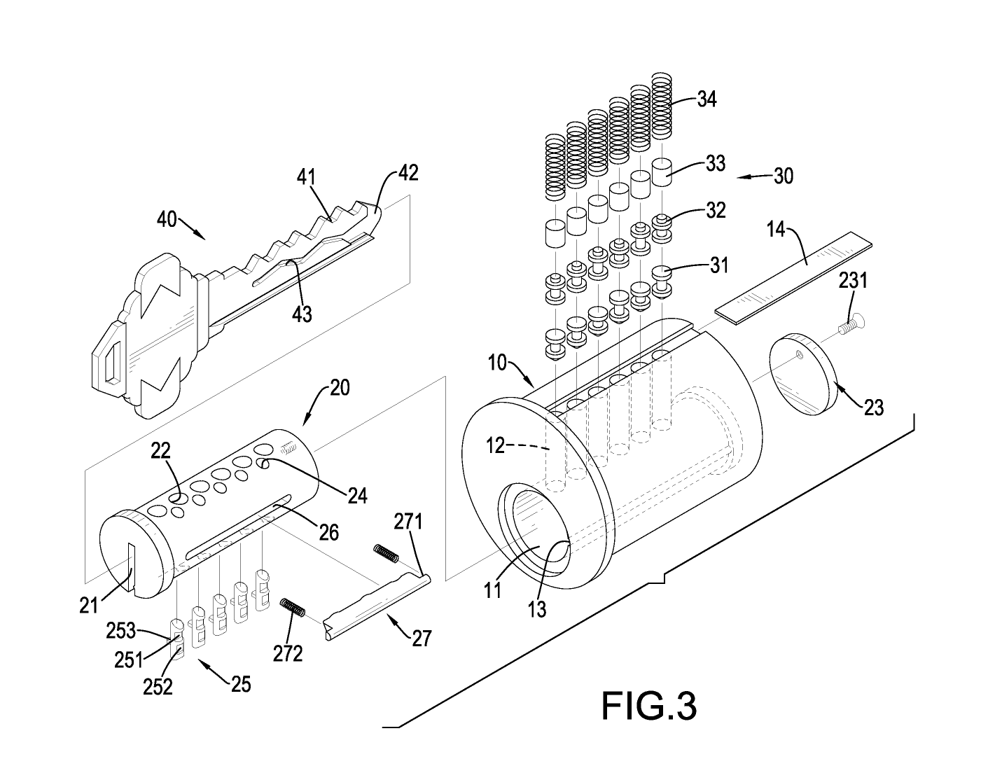

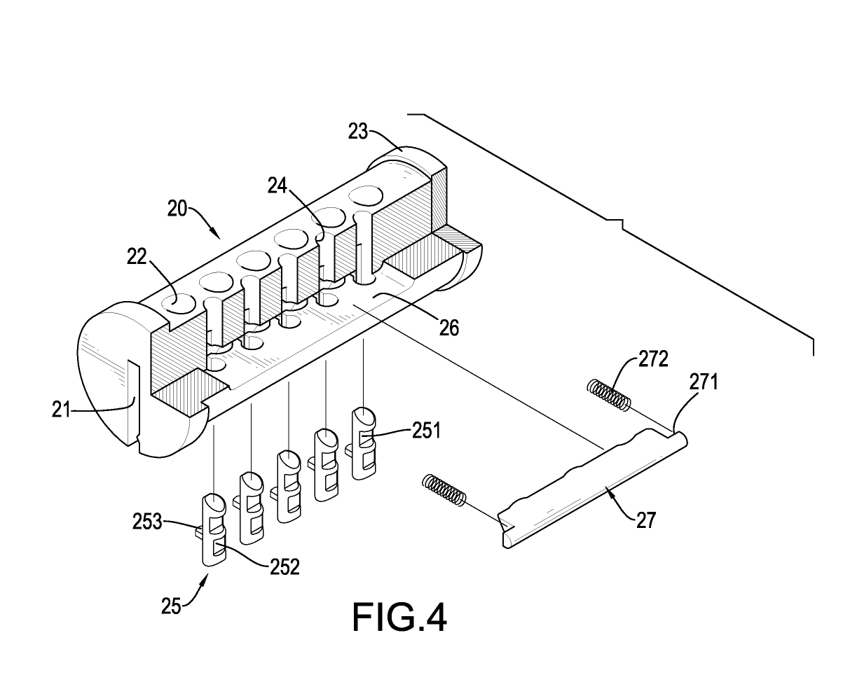

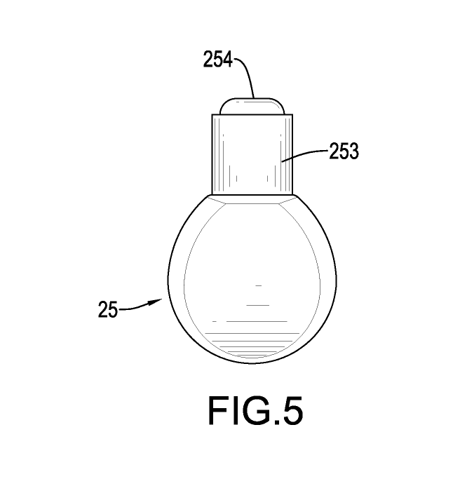

With reference to FIGS. 3 and 4, the sliding rods 25 are each respectively and slidably mounted in the sliding channels 24, and each sliding rod 25 has a top end, a bottom end, an outer side, an inner side, a releasing recess 251, a burglar-misleading recess 252 and a guiding post 253. With further reference to FIG. 5, the shapes of the top end and the bottom end of the sliding rod 25 are elliptical. The inner side of the sliding rod 25 faces the keyhole 21. The releasing recess 251 is formed in the outer side of the sliding rod 25 proximal to the top end of the sliding rod 25 and has a depth. The burglar-misleading recess 252 is formed in the outer side of the sliding rod 25 proximal to the bottom end of the sliding rod 25 below the releasing recess 251 and has a depth smaller than the depth of the releasing recess 251. The guiding post 253 is formed on and protrudes from the inner side of the sliding rod 25, extends into the keyhole 21 and has a free end. The relative positions of the guiding posts 253 on the sliding rods 25 may be different. Preferably, each one of the sliding rods 25 has a flange 254 formed on and protrudes from the free end of the guiding post 253. In addition, each one of the sliding rods 25 may has two or more guiding posts 253 formed on and protruding from the inner side of the sliding rod 25 at intervals.

The tab recess 26 is radially formed in the lock core 20, communicates with the sliding channels 24 and selectively faces the engaging slot 13 of the lock shell 10. In addition, the releasing recesses 251 of the sliding rods 25 selectively face the tab recess 26.

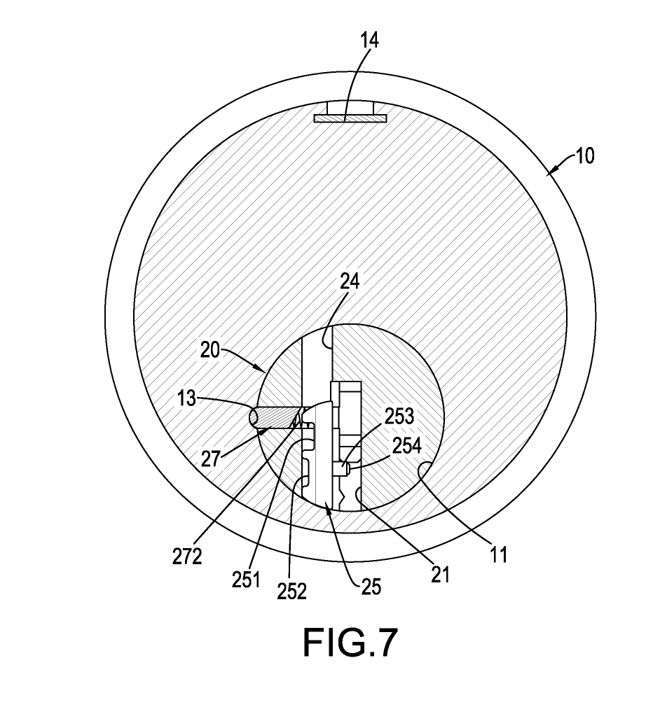

With reference to FIGS. 3 and 7, the engaging tab 27 is movably mounted between the engaging slot 13 of the lock shell 10 and the tab recess 26 of the lock core 20 and has an inner side, an outer side, two ends, two holding recesses 271 and two springs 272. The inner side of the engaging tab 27 faces the sliding channels 24. The outer side of the engaging tab 27 faces the engaging slot 13 of the lock shell 10 and selectively abuts the engaging slot 13 or the inner surface of the mounting recess 11 of the lock shell 10. The holding recesses 271 are formed in the inner side of the engaging tab 27 respectively at the ends of the engaging tab 27. The springs 272 are each respectively mounted in the holding recesses 271 and abut between the lock core 20 and the engaging tab 27. When the releasing recesses 251 of the sliding rods 25 face the tab recess 26, the engaging tab 27 may be retracted into the tab recess 26 and be separated from the engaging slot 13 of the lock shell 10.

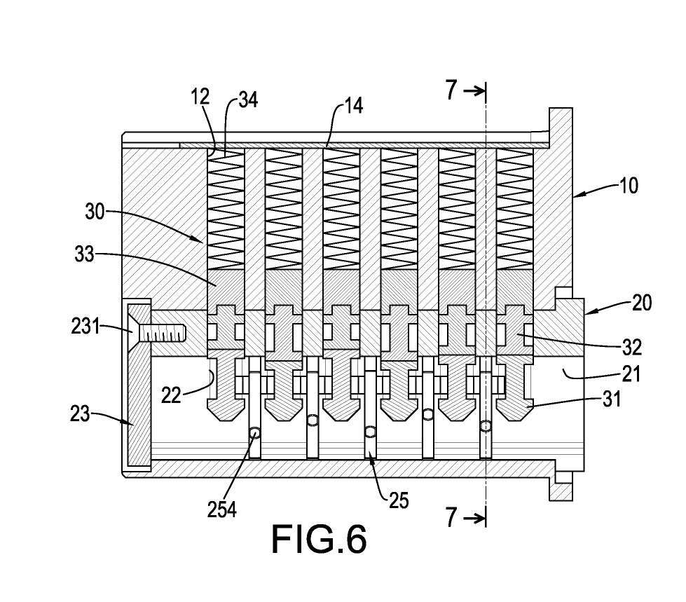

With reference to FIGS. 3 and 6, the pin device 30 is mounted between the lock shell 10 and the lock core 20 and has a default position and multiple pin sets. The pin sets are mounted in the upper and lower pin chambers 12, 22 of the lock shell 10 and the lock core 20, and each pin set has a lower pin 31, an upper pin 32, a mounting tube 33 and a returning spring 34.

The lower pins 31 have top ends, various lengths and are mounted slidably in the lower pin chambers 22 of the lock core 20. The upper pins 32 are mounted slidably in the lower pin chambers 22 and abut the lower pins 31, and each upper pin 32 has a top end and a bottom end. The bottom end of the upper pin 32 abuts the top end of a corresponding lower pin 31. The mounting tubes 33 are mounted slidably in the upper pin chambers 12 and the lower pin chambers 22, are each respectively mounted on the upper pins 32, and each mounting tube 33 has a bottom end and a top end. The bottom ends of the mounting tubes 33 are each respectively mounted around the top ends of the upper pins 32. The returning springs 34 are mounted in the upper pin chambers 12 between the mounting tubes 33 and the lid 14, and each returning spring 34 pushes the mounting tube 33 to enable the upper pin 32 to press against the lower pin 31 at the default position.

Since the lower pins 31 do not have uniform lengths, at the default position, the upper pins 32 are disposed at the interface between the lock shell 10 and the lock core 20 to prevent the lock core 20 from rotating relative to the lock shell 10.

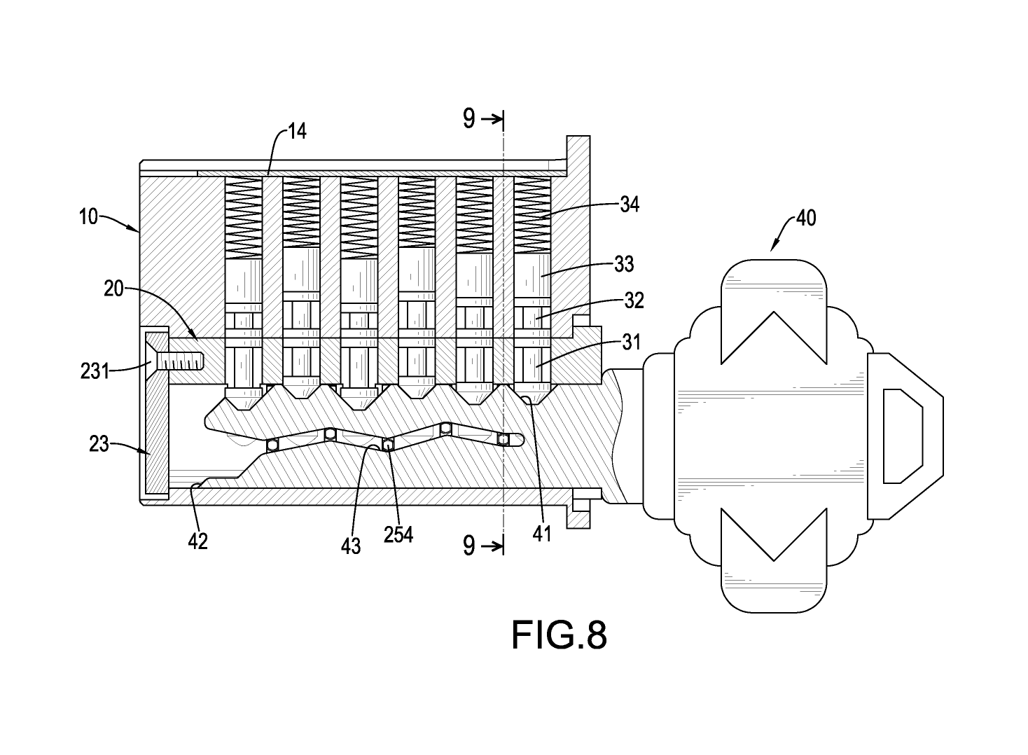

The key 40 is inserted into the keyhole 21 of the lock core 20, abuts the lower pins 31 of the pin device 30 and the guiding posts 253 of the sliding rods 25, and has an inserting end, a rotating end, a top face, a sidewall, multiple ridges 41, an enlarged opening 42 and a burglarproof slot 43. The inserting end of the key 40 is inserted into the keyhole 21 of the lock core 20. The rotating end of the key 40 can be held by a user's hand. With reference to FIGS. 3 and 8, the ridges 41 are formed on the top face of the key 40 proximal to the inserting end, abut and press the lower pins 31 of the pin device 30 upward to align the bottom ends of the upper pins 32 and the top ends of the lower pins 31 with the interface between the mounting recess 11 of the lock shell 10 and the lock core 20. However, as the springs 272 push the engaging tab 27 to engage in the engaging slot 13 of the lock shell 10, the lock core 20 still cannot be rotated by the key 40.

The enlarged opening 42 is formed in the sidewall of the key 40 at the inserting end of the key 40.

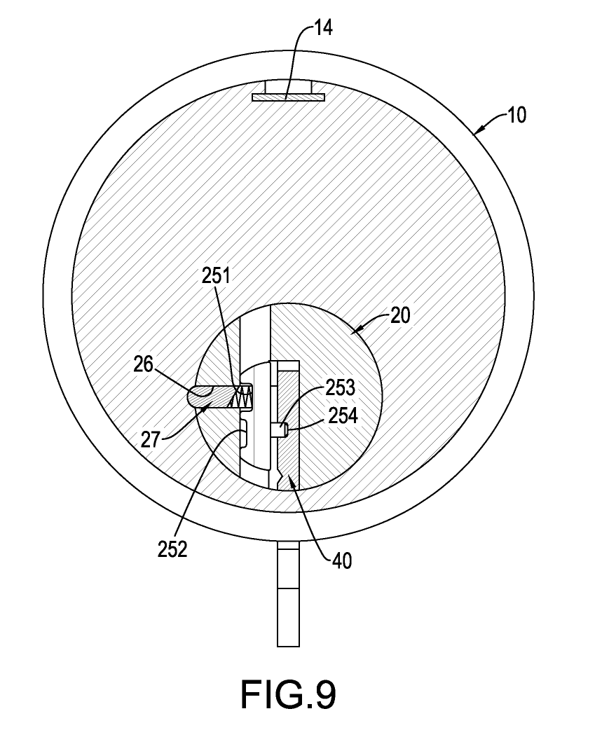

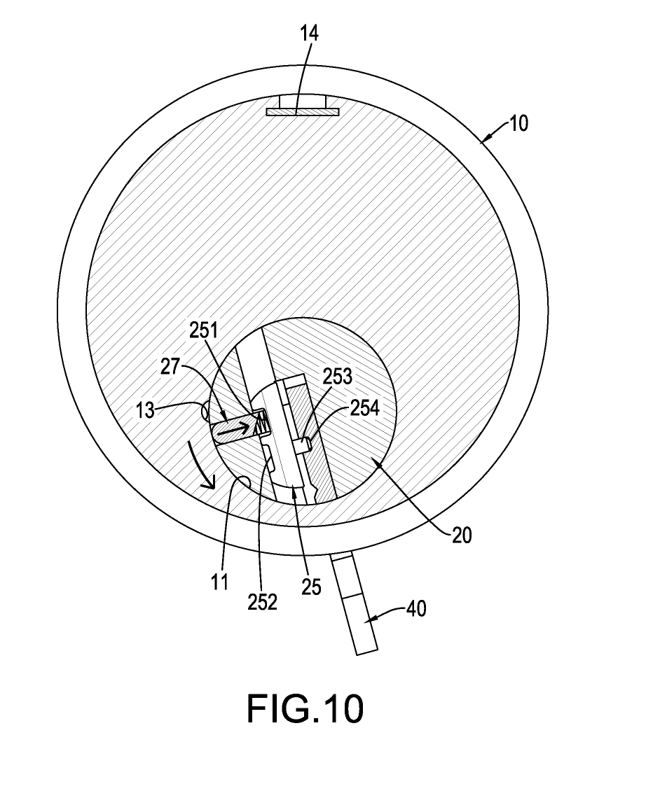

The burglarproof slot 43 is formed in the sidewall of the key 40 and communicates with the enlarged opening 42. The contour of the burglarproof slot 43 is corresponding to the positions of the guiding posts 253 of the sliding rods 25. In addition, when each one of the guiding rods 25 has two or more guiding posts 253, the key 40 also has two or more burglarproof slots 43. When the key 40 is inserted into the lock core 20, the guiding posts 253 of the sliding rods 25 can be moved into the burglarproof slot 43 via the enlarged opening 42. Then, with reference to FIGS. 8 and 9, the guiding posts 253 abut the key 40 in the burglarproof slot 43 to enable the releasing recesses 251 of the sliding rods 25 to align with the tab recess 26. Then, the engaging tab 27 can be moved into the releasing recesses 251 of the sliding rods 25 via the tab recess 26. With reference to FIG. 10, as the engaging tab 27 can be moved into the releasing recesses 251 of the sliding rods 25, when the key 40 is rotated, the engaging tab 27 will disengage from the engaging slot 13 of the lock shell 10 and is retracted into the releasing recesses 251 of the sliding rods 25 via the tab recess 26. Then, the lock core 20 can be rotated relative to the lock shell 10 to unlock the burglarproof lock core assembly.

According to the above-mentioned, the structural relationships between the lock shell 10, the lock core and the pin device 30 can provide twofold burglarproof effects to the burglarproof lock core assembly in accordance with the present invention. The first burglarproof effect is provided by the pins 31, 32 of the pin device 30. Since the bottom ends of the upper pins 32 and the top ends of the lower pins 31 are not aligned with the interface between the mounting recess 11 of the lock shell 10 and the lock core 20, the lock core 20 cannot be rotated relative to the lock shell 10 to unlock the burglarproof lock core assembly. The key 40 must be inserted into the keyhole 21 of the lock core 20 to align the bottom ends of the upper pins 32 and the top ends of the lower pins 31 with the interface between the mounting recess 11 of the lock shell 10 and the lock core 20 by the ridges 41 of the key 40. Even when the bottom ends of the upper pins 32 and the top ends of the lower pins 31 align with the interface between the mounting recess 11 of the lock shell 10 and the lock core 20 by the ridges 41 of the key 40, the lock core 20 still cannot be rotated relative to the lock shell 10 due to the engaging tab 27 of the lock core 20 engaging in the engaging slot 13 of the lock core 10.

Furthermore, the second burglarproof effect is provided by the sliding rods 25, the engaging tab 27 and the engaging slot 13 of the lock core 20 and the lock shell 10 relative to the enlarged opening 42 and the burglarproof slot 43 of the key 40. When the releasing recesses 251 of the sliding rods 25 are not aligned with the tab recess 26, the engaging tab 27 cannot be retracted into the releasing recesses 251 via the tab recess 26. Then, the engaging tab 27 of the lock core 20 engages in the engaging slot 13 of the lock shell 10, and the lock core 20 cannot be rotated relative to the lock shell 10 to unlock the burglarproof lock core assembly. When the key 40 is inserted into the keyhole 21 of the lock core 20, the sliding rods 25 will move upwardly or downwardly along the burglarproof slot 43 relative to the sliding channels 24 to enable the releasing recesses 251 to align with the tab recess 26. Then, the engaging tab 27 can be retracted into the releasing recesses 251 via the tab recess 26, and the lock core 20 can be rotated relative to the lock shell 10 to unlock the burglarproof lock core assembly.

In addition, when the burglar-misleading recesses 252 of the sliding rods 25 are aligned with the tab recess 26 by a thief, the engaging tab 27 can be retracted into the burglar-misleading recesses 252 via the tab recess 26, but the engaging tab 27 still engages in the engaging slot 13 of the lock shell 10 because the depths of the releasing recesses 251 of the sliding rods 25 are deeper than the depths of the burglar-misleading recesses 252. Then, the lock core 20 cannot be rotated relative to the lock shell 10. Therefore, the burglarproof effects of the burglarproof lock core assembly in accordance with the present invention can enable the burglarproof lock core assembly to provide an enhanced burglarproof effect.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A burglarproof lock core assembly having:
a lock shell having:
an outer surface;
a front side;
a rear side;
a mounting recess formed through the front side and the rear side of the lock shell and having an inner surface;
multiple upper pin chambers formed radially in the outer surface of the lock shell at intervals, aligning longitudinally with each other, and communicating with the mounting recess; and
an engaging slot formed through the front side of the lock shell and formed in the inner surface of the mounting recess;
a lock core mounted rotatably in the mounting recess of the lock shell and having:
an outer surface;
an interface defined between the outer surface of the lock core and the inner surface of the mounting recess of the lock shell;
an outer end;
an inner end;
a keyhole formed through the outer and inner ends and a part of the outer surface of the lock core;
multiple lower pin chambers formed radially in the outer surface of the lock core at intervals, communicating with the keyhole, aligning with, corresponding to and communicating with the upper pin chambers of the lock shell;
multiple sliding channels radially formed through the outer surface of the lock core at intervals, communicating with the keyhole and formed through the lock core near the lower pin chambers;
multiple sliding rods each respectively and slidably mounted in the sliding channels, and each sliding rod having
a top end;
a bottom end;
an outer side;
an inner side facing the keyhole;
a releasing recess formed in the outer side of the sliding rod proximal to the top end of the sliding rod;
a burglar-misleading recess formed in the outer side of the sliding rod proximal to the bottom end of the sliding rod below the releasing recess; and
a guiding post formed on and protruding from the inner side of the sliding rod and extending into the keyhole, wherein relative positions of the guiding posts on the sliding rods are different;
a tab recess radially formed in the lock core, communicating with the sliding channels and selectively facing the engaging slot of the lock shell, wherein the releasing recesses of the sliding rods selectively face the tab recess; and
an engaging tab movably mounted between the engaging slot of the lock shell and the tab recess of the lock core and having
an inner side facing the sliding channels;
an outer side facing the engaging slot of the lock shell and selectively abutting the engaging slot or the inner surface of the mounting recess of the lock shell;
two ends;
two holding recesses formed in the inner side of the engaging tab respectively at the ends of the engaging tab; and
two springs respectively mounted in the holding recesses and abutting between the lock core and the engaging tab; and
a pin device mounted between the lock shell and the lock core and having a default position and multiple pin sets mounted in the upper and lower pin chambers of the lock shell and the lock core.

2. The burglarproof lock core assembly as claimed in claim 1, wherein
the lock shell has a lid mounted detachably on the outer surface of the lock shell to cover the upper pin chambers; and
each pin set has
a lower pin mounted slidably in a corresponding lower pin chamber of the lock core and having a top end;
an upper pin mounted slidably in the corresponding lower pin chamber, abutting the lower pins and having a top end and a bottom end, the bottom end of the upper pin abutting the top end of the lower pin;
a mounting tube mounted slidably in a corresponding upper pin chamber and the corresponding lower pin chamber, mounted on the upper pins and having a top end and a bottom end, the bottom end of the mounting tube mounted around the top end of the upper pin; and
a returning spring mounted in the corresponding upper pin chamber between the mounting tube and the lid.

3. The burglarproof lock core assembly as claimed in claim 2, wherein the burglarproof lock core assembly has a key inserted into the keyhole of the lock core, abutting the lower pins of the pin device and the guiding posts of the sliding rods and having
an inserting end inserted into the keyhole of the lock core;
a rotating end;
a top face;
a sidewall;
multiple ridges formed on the top face of the key proximal to the inserting end, abutting and pressing the lower pins of the pin device upward to align the bottom ends of the upper pins and the top ends of the lower pins with the interface between the mounting recess of the lock shell and the lock core;
an enlarged opening formed in the sidewall of the key at the inserting end of the key; and
a burglarproof slot formed in the sidewall of the key, communicating with the enlarged opening and having a contour corresponding to the positions of the guiding posts of the sliding rods.

4. The burglarproof lock core assembly as claimed in claim 3, wherein the guiding post of each one of the guiding rods has a free end and a flange formed on and protruding from the free end of the guiding post.

5. The burglarproof lock core assembly as claimed in claim 4, wherein the releasing recess of each one of the sliding rods has a depth deeper than a depth of the burglar-misleading recess of a corresponding sliding rod.

6. The burglarproof lock core assembly as claimed in claim 5, wherein the shapes of the top end and the bottom end of each sliding rod are elliptical.

7. The burglarproof lock core assembly as claimed in claim 6, wherein the lock core has a cap mounted in the mounting recess of the lock shell and connected to the inner end of the lock core by a fastener to close the key hole.

8. The burglarproof lock core assembly as claimed in claim 1, wherein the guiding post of each one of the guiding rods has a free end and a flange formed on and protruding from the free end of the guiding post.

9. The burglarproof lock core assembly as claimed in claim 2, wherein the guiding post of each one of the guiding rods has a free end and a flange formed on and protruding from the free end of the guiding post.

10. The burglarproof lock core assembly as claimed in claim 1, wherein the releasing recess of each one of the sliding rods has a depth deeper than a depth of the burglar-misleading recess of the sliding rod.

11. The burglarproof lock core assembly as claimed in claim 2, wherein the releasing recess of each one of the sliding rods has a depth deeper than a depth of the burglar-misleading recess of the sliding rod.

12. The burglarproof lock core assembly as claimed in claim 3, wherein the releasing recess of each one of the sliding rods has a depth deeper than a depth of the burglar-misleading recess of a corresponding sliding rod.

13. The burglarproof lock core assembly as claimed in claim 1, wherein the shapes of the top end and the bottom end of each sliding rod are elliptical.

14. The burglarproof lock core assembly as claimed in claim 2, wherein the shapes of the top end and the bottom end of each sliding rod are elliptical.

15. The burglarproof lock core assembly as claimed in claim 3, wherein the shapes of the top end and the bottom end of each sliding rod are elliptical.

16. The burglarproof lock core assembly as claimed in claim 4, wherein the shapes of the top end and the bottom end of each sliding rod are elliptical.

18. The burglarproof lock core assembly as claimed in claim 1, wherein the lock core has a cap mounted in the mounting recess of the lock shell and connected to the inner end of the lock core by a fastener to close the key hole.

19. The burglarproof lock core assembly as claimed in claim 2, wherein the lock core has a cap mounted in the mounting recess of the lock shell and connected to the inner end of the lock core by a fastener to close the key hole.

20. The burglarproof lock core assembly as claimed in claim 3, wherein the lock core has a cap mounted in the mounting recess of the lock shell and connected to the inner end of the lock core by a fastener to close the key hole.
